(19) United States
(12) Patent Application Publication
(10) Pub. No.: US 2026/0342640 A1
(43) Pub. Date: Oct. 29, 2026

(54) SYSTEM AND METHOD FOR DYNAMIC ERROR FILTERING AND CHATTER REDUCTION IN STORAGE AND DISTRIBUTED NETWORK ENVIRONMENTS

(71) Applicant: BANK OF AMERICA CORPORATION, Charlotte, NC (US)

(72) Inventor: Manoj K. Srivastava, Newark, DE (US)

(73) Assignee: BANK OF AMERICA CORPORATION, Charlotte, NC (US)

(21) Appl. No.: 19/189,973

(22) Filed: Apr. 25, 2025

(51) Int. Cl. H04L 41/0604; H04L 43/062

(52) U.S. Cl. CPC H04L 41/0622; H04L 41/0627; H04L 43/062

(57) ABSTRACT

Systems, computer program products, and methods are described herein for trap chatter reduction. For example, a system may be configured to identify a first trap from a first networked device, where the first trap indicates a first triggered threshold event and a first timestamp associated with the first triggered threshold event, and identify a second trap from a second networked device, where the second trap indicates a second triggered threshold event associated with the first triggered threshold event and a second timestamp associated with the second triggered threshold event. The system may be configured to determine whether the first trap is a redundant alert signal by determining whether an interval between the first timestamp and the second timestamp exceeds an interval threshold, where the interval threshold is assigned based on network flow telemetry information between the first networked device and the second networked device.

### TECHNOLOGICAL FIELD

Example embodiments of the present disclosure relate to trap chatter reduction in distributed network environments.

### BACKGROUND

Modern distributed network environments generate a large volume of alerts and trap signals from various interconnected network devices, including servers, switches, routers, and storage components. In many cases, alerts may be triggered not by genuine fault conditions, but by peripheral or secondary effects that are reported as though they were independent problems. These alerts are often transmitted using low-level protocols, such as the Simple Network Management Protocol (SNMP), which typically lack detailed context or diagnostic insight. This results in alert streams that do not accurately reflect the severity or relevance of the underlying issue. The absence of meaningful differentiation makes it difficult for operational teams to identify which alerts correspond to actual system failures, leading to inefficient resource utilization, prolonged response times, and reduced focus on addressing high-impact operational issues.

Applicant has recognized limitations associated with the interpretation and management of alerts and trap signals in distributed network environments, including the difficulty of distinguishing between alerts that indicate true fault conditions and those that arise from peripheral or secondary effects. In view of these limitations, Applicant has developed technical approaches to address these and other related issues, as described in various embodiments of the present disclosure.

### BRIEF SUMMARY

Systems, methods, and computer program products are provided for trap chatter reduction in distributed network environments. For example, a system may include a network interface configured to communicate via a communication network, a non-transitory memory device including computer-readable program code stored thereon, and at least one processing device operatively coupled to the network interface and the non-transitory memory device. In some embodiments, the computer-readable program code may include computer instructions configured to, when executed by the at least one processing device, cause the at least one processing device to receive, using the network interface and via the communication network, a first trap from a first networked device, where the first trap indicates a first triggered threshold event and a first timestamp associated with the first triggered threshold event and identify the first triggered threshold event and the first timestamp. Additionally, or alternatively, the computer-readable program code may include computer instructions configured to, when executed by the at least one processing device, cause the at least one processing device to receive, using the network interface and via the communication network, a second trap from a second networked device, where the second trap indicates a second triggered threshold event associated with the first triggered threshold event and a second timestamp associated with the second triggered threshold event, and where the second networked device has a link relationship with the first networked device. In some embodiments, the computer-readable program code may include computer instructions configured to, when executed by the at least one processing device, cause the at least one processing device to identify the link relationship, the second triggered threshold event, and the second timestamp and determine whether the first trap is a redundant alert signal by determining whether an interval between the first timestamp and the second timestamp exceeds an interval threshold, where the interval threshold is assigned based on network flow telemetry information between the first networked device and the second networked device. Additionally, or alternatively, the computer-readable program code may include computer instructions configured to, when executed by the at least one processing device, cause the at least one processing device to trigger, only in response to determining that the interval exceeds the interval threshold, generation of a ticket associated with the first trap by transferring the first trap to a ticket generation engine and determine, in response to determining that the interval exceeds the interval threshold, that the first trap is a non-redundant alert signal.

In some embodiments, the non-transitory memory device may include computer-readable program code that, when executed by the at least one processing device, causes the at least one processing device to inhibit, in response to determining that the interval does not exceed the interval threshold, the generation of the ticket associated with the first trap and determine, in response to determining that the interval does not exceed the interval threshold, that the first trap is the redundant alert signal.

In some embodiments, the non-transitory memory device may include computer-readable program code that, when executed by the at least one processing device, causes the at least one processing device to receive, using the network interface and via the communication network, an alert information from a third networked device and associated with the first triggered threshold event, where the third networked device has the link relationship with the first networked device and correlate the alert information with the first trap.

In some embodiments, the non-transitory memory device may include computer-readable program code that, when executed by the at least one processing device, causes the at least one processing device to receive, using the network interface and via the communication network, a third trap from the first networked device, where the third trap indicates a third triggered threshold event and a third timestamp associated with the third triggered threshold event. Additionally, or alternatively, the non-transitory memory device may include computer-readable program code that, when executed by the at least one processing device, causes the at least one processing device to identify the third triggered threshold event and the third timestamp and trigger, in response to not receiving a fourth trap from the second network device, the generation of another ticket associated with the third trap. In some embodiments, the non-transitory memory device may include computer-readable program code that, when executed by the at least one processing device, causes the at least one processing device to determine, in response to not receiving a fourth trap from the second network device, that the third trap is the non-redundant alert signal.

In some embodiments, the non-transitory memory device may include computer-readable program code that, when executed by the at least one processing device, causes the at least one processing device to determine, based on the first triggered threshold event, a trap classification of whether the first trap is associated with a client-side alert or a server-side alert and, when triggering the generation of the ticket associated with the first trap, provide the trap classification to the ticket generation engine for inclusion in the ticket.

In some embodiments, the non-transitory memory device may include computer-readable program code that, when executed by the at least one processing device, causes the at least one processing device to receive, using the network interface and via the communication network, an alert information from a third networked device and associated with the first triggered threshold event, where the third networked device has the link relationship with the first networked device and, when triggering the generation of the ticket associated with the first trap, provide the alert information to the ticket generation engine for inclusion in the ticket.

In some embodiments, a protocol used by the first networked device to transmit the first triggered threshold event and the first timestamp may be different from another protocol used by the second networked device to transmit the second triggered threshold event and the second timestamp.

In some embodiments, the network flow telemetry information may include network bandwidth, data block analysis, and request rate monitoring data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for a trap chatter reduction system, in accordance with an embodiment of the disclosure.

FIG. 2 illustrates an exemplary system-level architecture for the trap chatter reduction system, in accordance with an embodiment of the disclosure.

FIG. 3 illustrates a process flow for the trap chatter reduction system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, identifiers such as “first,” “second,” “third,” and/or the like do not indicate a temporal relationship, unless explicitly stated. Such identifiers may modify instances of similar things and may be used to differentiate between each of the instances.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “module” refers to a functional component or unit configured to perform one or more specified tasks. The module may be implemented in hardware, software, firmware, or any combination thereof. In some embodiments, the module may include one or more processors, memory elements, or computer-readable instructions that, when executed, cause the module to perform the described functionality. The module can operate independently or in conjunction with other modules within the system, communicating via predefined interfaces, communication protocols, or data exchange mechanisms. Modules may be arranged in a distributed or centralized architecture and may be dynamically reconfigurable or adaptive to changing conditions or inputs.

As used herein, a “component” of an application may include a software package, a service, a resource, a module, and/or the like that includes a set of related functions and/or data. In some embodiments, a component may provide a source capability (e.g., a function, a business function, and/or the like) to an application including the component. In some embodiments, components of an application may communicate with each other via interfaces and may provide information to each other indicative of the services and/or functions that other components may utilize and/or how other components may utilize the services and/or functions. Additionally, or alternatively, components of an application may be substitutable such that a component may replace another component. In some embodiments, components may include objects, collections of objects, and/or the like.

As used herein, “trap” refers to an asynchronous, event-driven notification signal transmitted by a networked device to a centralized monitoring or management system to indicate the occurrence of a specific system event, operational condition. The trap may be formatted in accordance with the Simple Network Management Protocol (SNMP) or other telemetry standards, including but not limited to syslog, NetFlow, sFlow, or Internet Control Message Protocol (ICMP). The trap may include one or more data fields such as an event identifier, a timestamp, a networked device identifier, one or more status codes, and/or other diagnostic or contextual metadata. The trap may include one or more triggered threshold events and corresponding timestamps, where a triggered threshold event refers to a condition in which a monitored parameter exceeds or falls below a predefined operational limit. In some embodiments, the trap may be transmitted periodically or upon occurrence of an event-based trigger, depending on the device's internal monitoring configuration.

As used herein, “trap chatter” refers to a condition in which a network monitoring or management system receives an excessive volume of Simple Network Management Protocol (SNMP) trap messages or other event alerts generated using alternative communication protocols from one or more networked devices within a short time interval. Such messages may be triggered by repetitive, redundant, transient, or correlated fault conditions and may not each represent distinct or actionable incidents. Trap chatter may originate from rapidly fluctuating hardware states, link flapping, intermittent resource unavailability, cascading failure scenarios, duplicated fault signals propagating across multiple network layers, and/or the like. The accumulation of trap chatter may lead to alert fatigue, increased computational overhead for monitoring infrastructure, delayed recognition or resolution of critical fault conditions, and/or the like.

As used herein, “telemetry data” refers to diagnostic, performance, and operational data generated by the networked devices, including but not limited to performance metrics, fault indicators, resource utilization statistics, environmental parameters (e.g., CPU usage, power status), communication link states, port data, and/or the like.

The present disclosure relates to systems and methods for reducing trap chatter within distributed network environments. More particularly, it pertains to a trap chatter reduction system configured to evaluate, correlate, and suppress redundant or non-actionable alerts generated by networked devices, including but not limited to servers, switches, routers, and storage components. The system may include a decision engine that performs temporal and contextual analysis on trap signals to determine whether an alert corresponds to a distinct fault condition or stems from a commonly shared root cause.

In large-scale distributed computing environments, a wide range of networked devices may be configured to emit trap signals or alert notifications in response to threshold events. These traps are typically transmitted using low-level protocols such as Simple Network Management Protocol (SNMP), which provide limited diagnostic context. As a result, multiple devices may independently generate alerts in response to a single underlying event, such as a server shutdown or network interface failure. These alerts are often interpreted as separate fault conditions by traditional monitoring systems, despite their causal relationship. This leads to the propagation of excessive or duplicative alerts, commonly referred to as “trap chatter”, which obscures root cause identification, increases operational noise, and contributes to inefficient resource utilization and delayed incident response.

Accordingly, the present disclosure addresses the above limitations by, for example, implementing an inter-event interval analysis and time-based trap chatter determination logic. A decision engine may be configured to analyze trap timing, origin, protocol type, inter-device relationships, and/or the like to determine whether a given trap represents a distinct event or is derivative of an existing condition. By applying inter-event interval analysis and using telemetry data such as bandwidth usage, block-level transmission latency, and request rate metrics, the system may dynamically compute interval thresholds to distinguish real fault events from chatter. Traps classified as chatter may be suppressed from escalation, while meaningful events may be transmitted to downstream systems, such as a ticketing engine. This approach reduces alert fatigue, minimizes unnecessary ticket generation, and improves the accuracy and efficiency of incident management workflows.

What is more, the present disclosure provides a technical solution to a technical problem. As described herein, the technical problem includes the inability of conventional network monitoring systems to distinguish between trap signals that represent genuine fault conditions and those that are triggered by a common underlying event, leading to excessive alert noise, inefficient incident response, and unnecessary consumption of system resources. The technical solution presented herein allows for automated classification and suppression of trap chatter using a decision engine that performs inter-event interval analysis and correlation based on telemetry-derived thresholds. In particular, the trap chatter reduction system improves upon existing solutions by: (i) reducing the number of steps required to determine alert relevance, thereby conserving processing, storage, and network resources; (ii) improving classification accuracy, which reduces the number of false escalations and associated resource overhead; and (iii) eliminating manual alert filtering, thereby improving operational efficiency and accelerating root cause analysis.

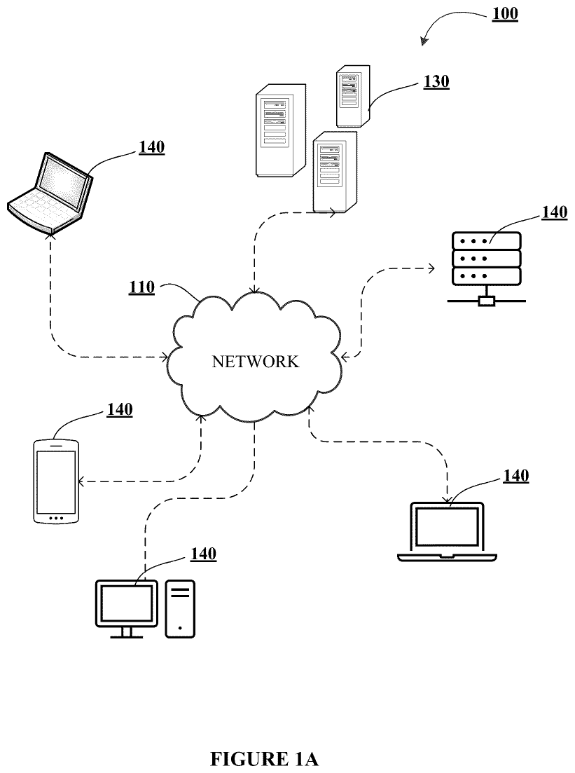

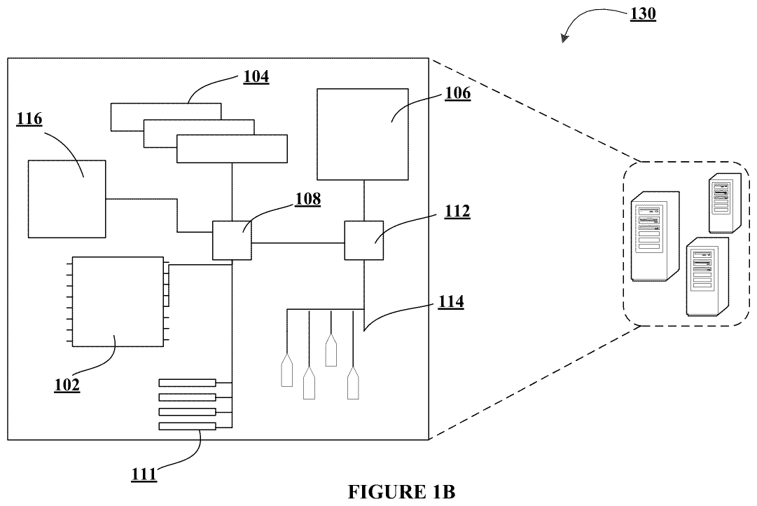

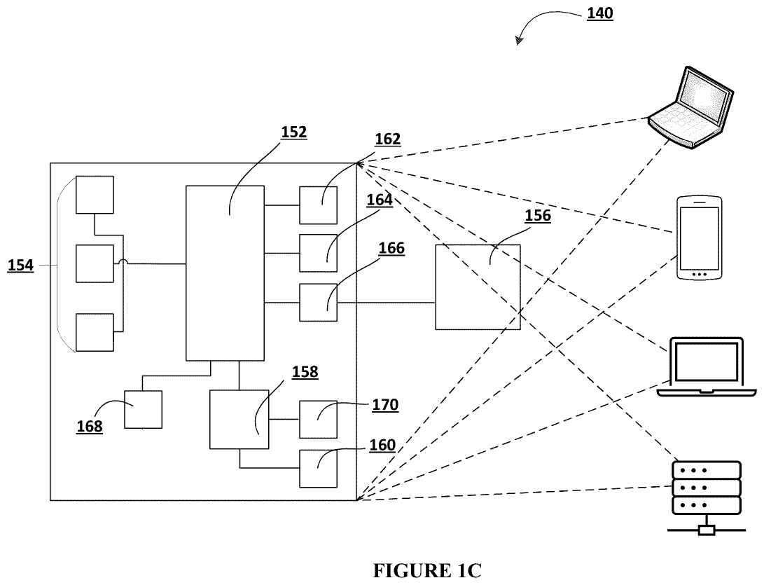

FIGS. 1A-1C illustrate technical components of an exemplary distributed computing environment 100 for trap chatter reduction system, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connected to the memory 104, and a low-speed interface 112 connecting to low speed bus 114 and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

In some embodiments, the system 130 may be implemented in a variety of computing configurations. For example, the system 130 may be implemented as a standalone server, a collection of servers operating in a clustered or distributed architecture, a rack-mounted server system, or a personal computing device, such as a desktop or laptop computer. In some implementations, components of the system 130 may be combined with one or more other systems of the same or similar type, with the resulting system being composed of multiple computing devices communicating via internal or external communication channels. The system 130 may be utilized to operate an institution or organization, or to provide computing services to the end-point device(s) 140, including but not limited to processing, storage, communication, monitoring, or control functionalities. In some embodiments, a trap chatter reduction system is configured to use one or more components, or a combination of components, of the system 130 to perform dynamic timeout sequence to reduce trap chatters in the distributed computing environment 100.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, and/or the like) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

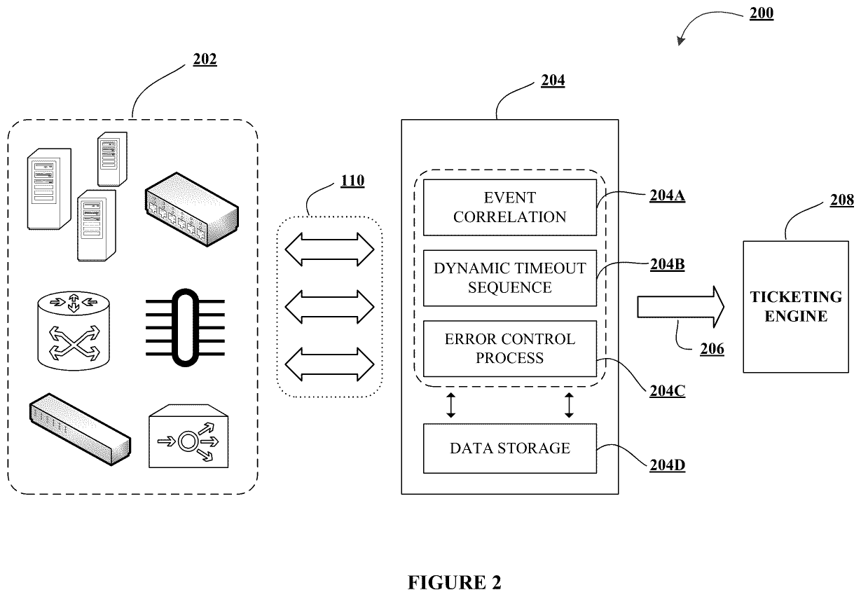

FIG. 2 illustrates an exemplary system-level architecture 200 for the trap chatter reduction system, in accordance with an embodiment of the present disclosure. As shown in FIG. 2, the system-level architecture 200 includes a set of networked devices 202, the network 110, a decision engine 204, an alert gateway 206, and a ticketing engine 208. In some embodiments, one or more components of the system-level architecture 200 may be implemented using one or more components of the system 130 illustrated in FIGS. 1A-1C. For example, the network 110 of FIG. 2 may be similar to the network 110 of FIG. 1A.

The networked device(s) 202 may comprise various hardware elements, including servers, routers, switches, hubs, firewalls, load balancers, storage controllers, edge gateways, and other components of a network infrastructure. Each networked device 202 may be configured to generate and transmit event-related alerts to the decision engine 204 for network monitoring and analysis.

Each networked device 202 may incorporate dedicated hardware components, including embedded processors, sensors, memory buffers, and firmware agents, configured to collect, evaluate, and transmit telemetry data or traps to the decision engine 204. For example, each of networked device 202 may include one or more of the components as shown and described herein with respect to FIGS. 1A-1C. Networked devices 202 may include routers, switches, servers, Host Bus Adapters (HBAs) operating within a storage area network (SAN) environment, and/or the like. For example, a router may be configured to monitor packet loss rates, error rates, or other diagnostic metrics, and may generate a trap upon detecting that a monitored value exceeds a predefined threshold. Similarly, servers configured within a SAN topology may utilize HBAs to transmit block-level data over communication protocols, such as Fibre Channel or Internet Small Computer Systems Interface (iSCSI). The HBAs may be configured to detect link failures, transport-layer errors, or I/O timeouts, and may generate corresponding diagnostic events or alert traps accompanied by a timestamp indicating the time of occurrence of the threshold-triggering condition.

In some implementations, the telemetry data and traps may be transmitted using one or more network monitoring protocols. For example, SNMP may be employed as a foundational protocol for device status monitoring, including interface states (e.g., up/down), processor utilization, and memory availability. As another example, Syslog may be used as an event-based protocol to log and transmit operational events, such as error conditions, warning signals, and configuration changes. In some embodiments, flow-based protocols such as NetFlow or sFlow may be utilized to monitor bandwidth usage, detect anomalous traffic patterns, and evaluate link saturation conditions. Additionally, or alternatively, Internet Control Message Protocol (ICMP) may be employed for lightweight diagnostics, including connectivity checks, round-trip time estimation, and packet loss detection. Such protocols may be used individually or in combination to enable comprehensive network monitoring and facilitate robust trap chatter reduction process.

In some embodiments, the networked devices 202 may be implemented as components within various zones of the distributed computing environment 100 illustrated in FIG. 1A. The networked devices 202 may be logically or physically integrated into the system 130, such as being coupled to its internal subsystems (e.g., processor 102, memory 104, storage device 106), or alternatively, positioned along the network 110 in association with the end-point device(s) 140.

The network 110, as illustrated in FIG. 1A, may facilitate communication between the networked devices 202 and the decision engine 204. In some embodiments, the network 110 may include wired, wireless, optical, or hybrid communication links, and may incorporate one or more local area networks (LANs), wide area networks (WANs), or enterprise backbone infrastructures. The communication protocols supported by the network 110 may include Transmission Control Protocol/Internet Protocol (TCP/IP), User Datagram Protocol (UDP), Simple Network Management Protocol (SNMP), Syslog, NetFlow, sFlow, Internet Control Message Protocol (ICMP), and other telemetry or event-streaming protocols suitable for transmitting network monitoring data to the trap chatter reduction system.

The decision engine 204 may be an engine of the trap chatter reduction system and may be implemented using one or more components of the system 130, including the processor 102, memory 104, storage device 106, high-speed interface 108, and low-speed interface 112 as illustrated in FIG. 1B. The telemetry data or traps generated by the networked devices 202 may be transmitted over the network 110 and received by the decision engine 204 for analysis. The decision engine 204 may be configured to monitor, analyze, and control the operational performance, availability, and integrity of the networked devices 202 and corresponding system events within a distributed computing environment (e.g., similar to the distributed computing environment 100 as shown and described herein with respect to FIG. 1A). In some embodiments, the system collects network telemetry data, such as performance metrics, network traffic flow, device health indicators, and traps or alerts generated by networked hardware components, using protocols including, but not limited to, Simple Network Management Protocol (SNMP), Syslog, and other standardized or proprietary logging methods. The decision engine 204 may be configured to perform an event correlation process 204A, implement a dynamic timeout sequence 204B, and execute error control procedures 204C, utilizing a data storage component 204D.

The event correlation process 204A may be configured to analyze temporal and contextual relationships among incoming telemetry data or traps received from one or more networked devices 202. The event correlation process 204A may determine whether events originate from causally related sources, such as a server reset for scheduled maintenance, exhibit adjacency across hardware layers, and/or represent duplicate reports of the same fault condition. The dynamic timeout sequence process 204B may be configured to implement inter-event interval analysis and time-based trap chatter determination logic, where events arriving within a computed interval threshold are potentially suppressed as trap chatter. The computed interval threshold may be dynamically determined based on network flow telemetry information, including network bandwidth usage, data block analysis, request rate monitoring data, and/or predefined policy rules.

The error control process 204C may be configured to analyze incoming traps and classify the associated trap-generating events based on origin and operational characteristics. Additionally, or alternatively, error control process 204C may extend the trap chatter determination process across multiple network communication protocols by employing inter-event interval analysis and time-based trap chatter determination logic. Furthermore, the error control process 204C may incorporate intelligent retry mechanisms tailored to distinguish between server-side alerts requiring further analysis and client-side alerts that should not trigger unnecessary retries.

The data storage component 204D of the decision engine 204 may be configured to log telemetry data or traps from networked devices 202, trap classification outcomes, suppression decisions, protocol-handling results, and/or the like. The data storage component 204D may store network topology maps and connectivity information to represent the arrangement of networked devices 202, facilitating the correlation of traps or event signals from devices exhibiting physical or logical connectivity. The event correlation process 204A, dynamic timeout sequence process 204B, error control process 204C, and data storage component 204D may collaboratively execute trap chatter determination logic on incoming traps.

The alert gateway 206 may serve as a communication interface between the decision engine 204 and the ticketing engine 208. In some embodiments, the alert gateway 206 may be implemented using one or more I/O devices 116 and high-speed interfaces 108, or low-speed interface 112 of the system 130, configured to transmit non-redundant alerts that are filtered from the decision engine 204. The alert gateway 206 may normalize, encrypt, or reformat the alert metadata prior to forwarding it to downstream systems.

The ticketing engine 208 may be configured to assign and generate tickets corresponding to actionable alerts received via the alert gateway 206. The ticketing engine 208 may be operatively integrated with the decision engine 204 and may be further configured to associate each generated ticket with metadata including one or more of a networked device identifier, a trap or alert type, an associated timestamp, correlation data linking the event to related alerts, other diagnostic context, and/or the like. The ticketing engine 208 may generate and output the ticket to a designated user and/or system interface to facilitate investigation and/or remediation of the networked device and/or infrastructure component associated with the triggering alert. Execution of ticketing logic may use components of the system 130, including the processor 102, memory 104, storage device 106, high-speed interfaces 108, low-speed interface 112, and/or the like of the system 130.

It is to be understood that the structure of the system-level architecture 200 and its components, connections and relationships, and their functions, are meant to be exemplary only, and are not meant to limit implementations of the disclosures described and/or claimed in this document. For example, the system-level architecture 200 may include more, fewer, or different components. As another example, some or all of the portions of the system-level architecture 200 may be combined into a single portion, or all of the portions of the trap reduction system may be separated into two or more distinct portions. As another example, the decision engine 204, the alert gateway 206, and the ticketing engine 208 may be implemented as a unified component within a single software module and/or execution environment. In some implementations, each may be separately deployed as distributed services or microservices across multiple computing nodes within the distributed computing environment 100.

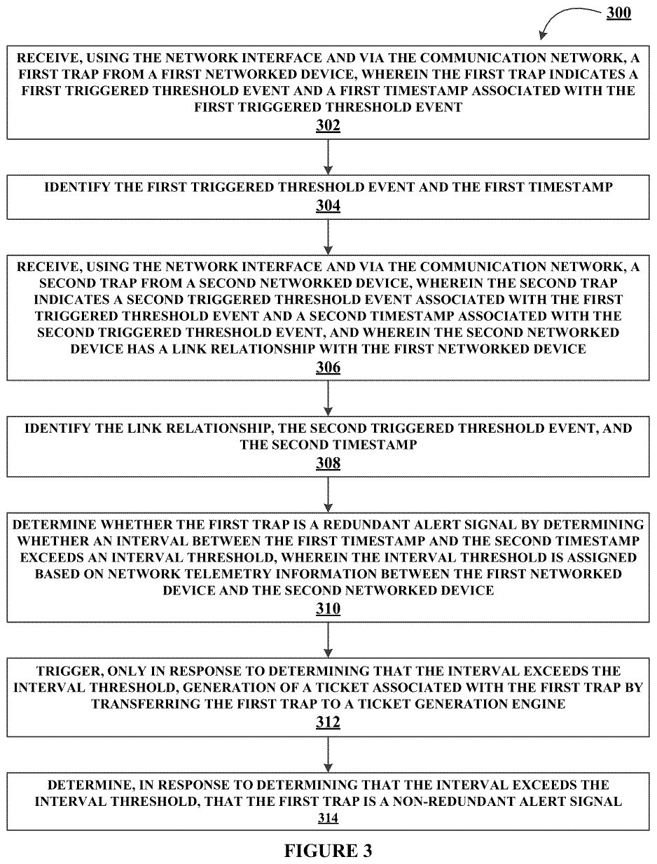

FIG. 3 illustrates a process flow 300 for trap chatter reduction, in accordance with an embodiment of the disclosure. In some embodiments, the trap chatter reduction system (e.g., similar to one or more of the systems shown and described herein with respect to FIGS. 1A-1C) may perform one or more of the steps of process flow 300. Additionally, or alternatively, a system including the system-level architecture 200 as shown and described herein with respect to FIG. 2 may perform one or more of the steps of process flow 300.

As shown in block 302, the process flow 300 may include the step of receiving, using the network interface and via the communication network, a first trap from a first networked device, where the first trap indicates a first triggered threshold event and a first timestamp associated with the first triggered threshold event. For example, and in some embodiments, a trap chatter reduction system may be configured to receive a first trap via the network 110 from a first networked device within the distributed computing environment 100.

In some embodiments, the trap chatter reduction system may be configured to receive a trap (e.g., a first trap) including trap messages from a networked device (e.g., a first networked device). The trap message may be generated in accordance with a protocol used by the networked device and may include an event identifier, a timestamp, a networked device identifier, one or more status codes, and/or additional diagnostic or contextual metadata. For example, in an implementation using SNMP, the trap chatter reduction system may receive an SNMP trap message from a networked switch upon detection of a port transition to a down state due to the shutdown of a connected server. The SNMP trap may include a specific object identifier (OID), such as 1.3.6.1.6.3.1.1.5.3, corresponding to a linkDown event, a timestamp indicating when the port state changed, the interface index identifying the affected port, administrative and operational status values of the interface, a source IP address associated with the switch, and/or the like.

As shown in block 304, the process flow 300 may include the step of identifying the first triggered threshold event and the first timestamp. In example embodiments, the trap chatter reduction system may be configured to use a decision engine (e.g., similar to the decision engine 204 as shown and described herein with respect to FIG. 2) to identify the first triggered threshold event and the first timestamp extracted from the trap message of the first trap.

In some embodiments, the decision engine may be configured to identify a triggered threshold event and a corresponding timestamp from a received trap. The decision engine may support multiple communication protocols and may be configured to extract trap messages across diverse protocol formats. The decision engine may further include a data storage component (e.g., similar to the data storage component 204D as shown and described herein with respect to FIG. 2) configured to store network topology maps and connectivity data, which may be used to correlate the received trap with other traps reported by additional networked devices.

As shown in block 306, the process flow 300 may include the step of receiving, using the network interface and via the communication network, a second trap from a second networked device, where the second trap indicates a second triggered threshold event associated with the first triggered threshold event and a second timestamp associated with the second triggered threshold event, and where the second networked device has a link relationship with the first networked device. For example, the trap chatter reduction system may be configured to receive the second trap via a network (e.g., similar to the network 110 as shown and described herein with respect to FIGS. 1A and 2) from second networked devices within a distributed computing environment (e.g., similar to the distributed computing environment 100 as shown and described herein with respect to FIG. 1A).

In some embodiments, the second networked device may be linked to the first networked device through a physical and/or logical connection, such as a shared port, adjacent node relationship, direct uplink path, and/or the like. The second networked device may detect a triggered threshold event and generate a second trap including a trap message associated with the detected event. The trap message may include metadata such as a timestamp, a device identifier, an event type code, a status indicator, and/or the like. Upon generation, the second trap may be transmitted to the trap chatter reduction system via the network.

As shown in block 308, the process flow 300 may include the step of identifying the link relationship, the second triggered threshold event, and the second timestamp. In some embodiments, the trap chatter reduction system may configured to use the decision engine to identify the second triggered threshold event and the second timestamp extracted from the trap message of the second trap.

In some embodiments, the decision engine may be configured to identify the second triggered threshold event and the second corresponding timestamp from the received second trap. The decision engine may be configured to utilize the data storage component to determine a link relationship between the first networked device and the second networked device based on stored network topology data, connectivity metadata, and/or the like. Upon identifying such a relationship, the decision engine may associate the second trap with the first trap for further analysis, correlation, trap chatter reduction, and/or the like.

As shown in block 310, the process flow 300 may include the step of determining whether the first trap is a redundant alert signal by determining whether an interval between the first timestamp and the second timestamp exceeds an interval threshold, where the interval threshold is assigned based on network flow telemetry information between the first networked device and the second networked device. As used herein, “inter-event interval analysis and time-based trap chatter determination logic” may refer to methods employed by the decision engine to assess whether multiple incoming traps represent redundant notifications indicative of the same underlying event or condition (i.e., trap chatter). For example, the inter-event interval analysis may calculate the elapsed time interval between successively received traps and/or alerts, while the time-based trap chatter determination logic may compare this calculated interval against a predetermined and/or dynamically computed threshold interval. By applying this approach, the decision engine may effectively filter repetitive and/or causally related alerts, suppressing redundant notifications, thereby reducing unnecessary event escalations. Such interval thresholds may be dynamically computed based on network flow telemetry, including network bandwidth usage, data block analysis, request-rate monitoring data, and/or the like and/or may be retrieved from historically stored values.

In some embodiments, the trap chatter reduction system may be configured to utilize the decision engine to determine whether the first trap constitutes trap chatter by employing inter-event interval analysis and/or time-based trap chatter determination logic. This logic may involve calculating the time interval between two temporally adjacent traps, such as a first trap generated by the first networked device and a second trap generated by the second networked device, and comparing the calculated interval to a predetermined and/or dynamically computed interval threshold. If the interval is less than the threshold, the first trap may be classified as a redundant alert signal, indicating that it likely originates from a causally related event and/or a duplicate notification of the same fault condition, rather than from an independent failure. If the interval exceeds the threshold, the first trap may be considered a non-redundant and/or distinct alert. The interval threshold may be dynamically computed or retrieved from the data storage component, which may store previously computed interval thresholds associated with communications between the first and second networked devices. The interval threshold may be computed based on network flow telemetry information, which may include network bandwidth measurements, data block analysis, request-rate monitoring data, and/or the like.

In some embodiments, the trap chatter reduction system may detect conditions in which the first networked device transmits a first trap, but no corresponding trap is transmitted by a second networked device within the expected interval window. For example, the first trap may be generated in response to a localized fault condition, and the absence of a second trap from a linked or adjacent device may indicate that the event is isolated rather than correlated. In such cases, the decision engine may determine that the first trap does not constitute trap chatter and should not be suppressed. Instead, the system may treat the first trap as a non-redundant alert signal and may escalate it for ticket generation and/or further diagnostic processing. Additionally, the decision engine may store metadata indicating the absence of a corroborating trap in the data storage component, allowing for future correlation analysis and refinement of trap suppression logic.

For example, and in some embodiments, the first networked device may include a switch configured to detect a port-down event resulting from a connected server being powered off, thereby triggering the transmission of a first trap indicating the detected port-down event. The second networked device, which may include another switch physically connected to the first switch via a trunk port and/or uplink interface, may subsequently detect a related port-down event. In response to this detection, the second switch may generate a second trap. Although the first and second traps originate from different devices, the underlying root cause may be attributed to a common event (e.g., the server shutdown). The decision engine may be configured to correlate the second trap with the first trap based on link relationship metadata derived from the first and second triggered threshold events, interface mapping information, network topology data retrieved from the data storage component, and/or the like.

Furthermore, the decision engine may be configured to associate the root cause of the first trap with a server-down event associated with a third networked device, such as a server connected to the first networked device (e.g., the first switch). In some embodiments, such correlation may be established upon receiving a server-related event (e.g., a reboot sequence associated with scheduled maintenance) and/or a failure alert originating from the third networked device, and/or from one or more additional networked devices communicatively associated with the first networked device. Such alerts may be transmitted using either the same and/or differing communication protocols from those used by the first and second switches. The decision engine may leverage this cross-device correlation to determine that the traps generated by the first and second switches do not represent independent alerts, but instead reflect a common root cause stemming from the third networked device. In some embodiments, the correlation result may be included in the metadata transmitted to a ticketing engine (e.g., similar to the ticketing engine 208 as shown and described herein with respect to FIG. 2) to inform ticket generation and/or support accurate root cause attribution.

The interval threshold may be computed based on network flow telemetry information, which may include network bandwidth measurements, data block analysis, request-rate monitoring data, and/or the like. In example embodiments, the network bandwidth measurements may include standard estimations of data transfer capacity across the network, enabling the system to calibrate expected delays associated with data transmission for computing the interval threshold between networked devices.

In some embodiments, data block analysis may be performed by the decision engine to evaluate timing characteristics associated with standard data block transmissions (e.g., 4K blocks) between servers and storage components, such as Host Bus Adapters (HBAs) operating in a Storage Area Network (SAN) environment. In example embodiments, the decision engine may probe the SAN environment by issuing empty or diagnostic packets and measuring the round-trip latency associated with read and write operations. The observed transmission and reception timing for such standard-sized data blocks may be compared against expected timing benchmarks and benchmark measures stored in the data storage component. These benchmarks and/or measures may include historical latency pattens, baseline performance thresholds, vendor-defined timing specifications that characterize normal or healthy infrastructure performance, and/or the like. For example, if a healthy storage path completes a 4K block transfer in approximately 1 millisecond, but the measured delay consistently exceeds this benchmark (e.g., rising to 2-3 milliseconds), the system may interpret the deviation as indicative of degraded infrastructure, such as a weak fiber cable connection, an unstable disk interface, faulty media sectors, and/or the like. These deviations may be used to compute or adjust the interval threshold for trap evaluation. For example, longer and/or inconsistent block transfer delays may indicate potential systemic issues that may require extending the inter-event interval threshold, thereby reducing false positives from closely spaced traps triggered by the same underlying fault condition. As another example, consistent and minimal block transfer times may justify a shorter interval threshold, allowing the system to more promptly identify distinct fault events.

For the request-rate monitoring data, the decision engine may function as a monitoring server configured to issue repeated requests (e.g., ping signals) to a plurality of networked devices and to collect timing and frequency data from the corresponding responses. The responses received from these devices may be analyzed to detect abnormal response delays, suppressed communication, potential device outages, and/or the like. Patterns derived from this analysis may be used to influence the interval threshold computation as part of the inter-event interval analysis.

The telemetry parameters may be used individually and/or in combination to evaluate baseline network behavior and determine dynamic interval thresholds that reflect current network conditions. The resulting interval threshold may be utilized by the decision engine during inter-event interval analysis to detect and suppress redundant trap signals associated with transient and/or correlated network events. The telemetry-driven interval threshold allows the decision engine to more accurately distinguish between legitimate fault events and redundant or transient alerts indicative of trap chatter.

In some embodiments, the decision engine may be configured to determine the interval threshold between networked devices on a pre-assigned schedule and/or at regular intervals. The interval threshold may be periodically recalibrated based on updated network flow telemetry information to maintain responsiveness to evolving network conditions, communication latency, performance fluctuations of networked devices, and/or the like within the distributed computing environment. The recalibration process may be triggered in response to detecting significant variations in throughput metrics, link congestion levels, packet delay statistics, and/or the like. Additionally, the interval threshold may be recalibrated upon the occurrence of anomaly detection events, updates to network topology mappings, firmware upgrades on monitored devices, changes in workload distribution associated with one or more network segments, and/or the like. The decision engine may be further configured to store the recalibrated interval threshold in the data storage component. The stored interval threshold may be referenced during subsequent trap chatter determination processes.

In some embodiments, the first networked device and the second networked device may generate traps using different communication protocols, such as Simple Network Management Protocol (SNMP), streaming telemetry, proprietary alert formats, and/or alternative data transmission mechanisms including aggregators or jumbo IP packets used for network-wide data consolidation. The decision engine may be configured to normalize trap data across these diverse protocol types by extracting the triggered threshold events and corresponding timestamps from each respective trap, without consideration of protocol syntax or transport format. In this way, the decision engine may correlate trap content based on event metadata, such as interface identifiers, device role, and/or link relationships, to evaluate whether the first trap constitutes trap chatter in view of the second trap. The extracted timestamps may be used in conjunction with the interval threshold to perform inter-event interval analysis, enabling the system to determine whether the traps are causally related and/or represent distinct fault events. By supporting cross-protocol event correlation, including protocols involving bulk data transport, telemetry aggregation, and/or packet-level consolidation, the decision engine may enhance trap chatter suppression across multi-protocol network environments.

As shown in block 312, the process flow 300 may include the step of triggering, only in response to determining that the interval exceeds the interval threshold, generation of a ticket associated with the first trap by transferring the first trap to a ticket generation engine. In example embodiments, the trap chatter reduction system may be configured to trigger generation of a ticket associated with the first trap based on a determination by the decision engine that the interval between the first timestamp and the second timestamp exceeds the interval threshold.

In some embodiments, the trap chatter reduction system may generate a ticket associated with the incoming trap (e.g., the first trap) by transmitting the incoming trap and its metadata to the ticketing engine via an alert gateway (e.g., similar to the alert gateway 206 as shown and described herein with respect to FIG. 2). The metadata may include, but is not limited to, the timestamp of triggered threshold event, a device identifier of the first networked device, link relationship of the networked devices, and/or any correlated event information derived from related alerts and/or traps reported from one or more networked devices associated with the first networked device. The alert gateway may serve as a communication interface between the decision engine and the ticketing engine. Upon receipt of the trap and associated metadata, the ticketing engine may be configured to instantiate a ticket object, assign a priority level, and store the ticket in a repository accessible to IT personnel and/or automated remediation workflows.

In some embodiments, the decision engine may be configured to analyze an incoming trap (e.g., first trap) and classify a trap-generating event based on the incoming trap's origin and/or operational characteristics. Upon determining that the generation of a ticket for the incoming trap (e.g., first trap) is triggered, the decision engine may further transmit associated error classification information to the ticketing engine.

The decision engine may be configured to differentiate incoming traps (e.g., the first trap) into (i) client-side alerts, which may include user-originated, syntactic, and/or front-end invocation issues (e.g., errors arising from a web interface, mobile application user interface, desktop graphical user interface, and/or the like), and (ii) server-side and/or system-originated alerts, representing issues detected within backend infrastructure components of a system. Server-side alerts may further be classified to distinguish Storage Area Network (SAN)-related issues, such as Host Bus Adapter (HBA) timeouts and/or disk access anomalies, from other non-SAN-related infrastructure concerns. Upon determining that the incoming trap requires ticket generation, the decision engine may transmit the corresponding error classification information along with the incoming trap and the associated metadata to the ticketing engine. The error classification information may subsequently be utilized by the ticketing engine to assign an appropriate priority level to the generated ticket.

In some embodiments, the decision engine may be configured to implement intelligent retry logic for analyzing trap-generating events associated with server-side alerts. The trap chatter reduction system may apply smart retry mechanisms selectively to backend infrastructure alerts, while avoiding unnecessary retries for client-side alerts, thereby optimizing system resource utilization and reducing error chatter. For example, in a Storage Area Network (SAN) environment, the decision engine may monitor retry behavior of Host Bus Adapters (HBAs) attempting to read from storage devices. A persistently high retry count may be indicative of hardware issues, such as a faulty cable, a bad disk sector, and/or the like. The decision engine may use the results of this retry analysis to pinpoint the root cause of the trap-generating event and to calibrate its error-handling strategy accordingly. In some embodiments, the retry evaluation outcome, including diagnostic indicators identifying specific hardware components and/or interfaces exhibiting abnormal behavior, may be transmitted to the ticketing engine along with the corresponding trap and metadata. This enables more precise ticket generation, facilitates faster root cause analysis, and supports automated remediation workflows.

As shown in block 314, the process flow 300 may include the step of determining, in response to determining that the interval exceeds the interval threshold, that the first trap is a non-redundant alert signal. In example embodiments, the decision engine may be configured to determine that the first trap constitutes trap chatter to be suppressed when the time interval between the first and second traps is less than the interval threshold. Such a determination may indicate that the network link between the first networked device and the second networked device is operating within expected parameters, and that both devices are reporting alerts resulting from a single, shared underlying condition rather than independent fault events.

In some embodiments, upon determining that the first trap constitutes trap chatter, the decision engine may be configured to suppress transmission of the trap to downstream systems, such as the ticketing engine, and to store the suppression result in the data storage component. The suppression process may include marking the trap as redundant, halting its propagation, and/or recording associated metadata including the trap type, originating device, timestamps, correlation identifiers, and/or the reason for suppression. This information may be persistently logged to support traceability, enable retrospective diagnostics, and/or facilitate recalibration of the trap chatter reduction logic. In certain implementations, the suppression result may further include a suppression code or tag that links the suppressed trap to previously correlated traps, allowing the system to maintain a clear record of event lineage and causal relationships across networked devices.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for trap chatter reduction in distributed network environments, the system comprising:
a network interface configured to communicate via a communication network;
a non-transitory memory device comprising computer-readable program code stored thereon; and
at least one processing device operatively coupled to the network interface and the non-transitory memory device, wherein the computer-readable program code comprises computer instructions configured to, when executed by the at least one processing device, cause the at least one processing device to:
receive, using the network interface and via the communication network, a first trap from a first networked device, wherein the first trap indicates a first triggered threshold event and a first timestamp associated with the first triggered threshold event;
identify the first triggered threshold event and the first timestamp;
receive, using the network interface and via the communication network, a second trap from a second networked device, wherein the second trap indicates a second triggered threshold event associated with the first triggered threshold event and a second timestamp associated with the second triggered threshold event, and wherein the second networked device has a link relationship with the first networked device;
identify the link relationship, the second triggered threshold event, and the second timestamp;
determine whether the first trap is a redundant alert signal by determining whether an interval between the first timestamp and the second timestamp exceeds an interval threshold, wherein the interval threshold is assigned based on network flow telemetry information between the first networked device and the second networked device;
trigger, only in response to determining that the interval exceeds the interval threshold, generation of a ticket associated with the first trap by transferring the first trap to a ticket generation engine; and
determine, in response to determining that the interval exceeds the interval threshold, that the first trap is a non-redundant alert signal.

2. The system of claim 1, wherein the non-transitory memory device comprises computer-readable program code that, when executed by the at least one processing device, further causes the at least one processing device to:
inhibit, in response to determining that the interval does not exceed the interval threshold, the generation of the ticket associated with the first trap; and
determine, in response to determining that the interval does not exceed the interval threshold, that the first trap is the redundant alert signal.

3. The system of claim 2, wherein the non-transitory memory device comprises computer-readable program code that, when executed by the at least one processing device, further causes the at least one processing device to:
receive, using the network interface and via the communication network, an alert information from a third networked device and associated with the first triggered threshold event, wherein the third networked device has the link relationship with the first networked device; and
correlate the alert information with the first trap.

4. The system of claim 1, wherein the non-transitory memory device comprises computer-readable program code that, when executed by the at least one processing device, further causes the at least one processing device to:
receive, using the network interface and via the communication network, a third trap from the first networked device, wherein the third trap indicates a third triggered threshold event and a third timestamp associated with the third triggered threshold event;
identify the third triggered threshold event and the third timestamp;
trigger, in response to not receiving a fourth trap from the second network device, the generation of another ticket associated with the third trap; and
determine, in response to not receiving a fourth trap from the second network device, that the third trap is the non-redundant alert signal.

5. The system of claim 1, wherein the non-transitory memory device comprises computer-readable program code that, when executed by the at least one processing device, further causes the at least one processing device to:
determine, based on the first triggered threshold event, a trap classification whether the first trap is associated with a client-side alert or a server-side alert; and
when triggering the generation of the ticket associated with the first trap, provide the trap classification to the ticket generation engine for inclusion in the ticket.

6. The system of claim 1, wherein the non-transitory memory device comprises computer-readable program code that, when executed by the at least one processing device, further causes the at least one processing device to:
receive, using the network interface and via the communication network, an alert information from a third networked device and associated with the first triggered threshold event, wherein the third networked device has the link relationship with the first networked device; and
when triggering the generation of the ticket associated with the first trap, provide the alert information to the ticket generation engine for inclusion in the ticket.

7. The system of claim 1, wherein a protocol used by the first networked device to transmit the first triggered threshold event and the first timestamp is different from another protocol used by the second networked device to transmit the second triggered threshold event and the second timestamp.

8. The system of claim 1, wherein the network flow telemetry information comprises network bandwidth, data block analysis, and request rate monitoring data.

9. A computer program product for trap chatter reduction in distributed network environments, wherein the computer program product comprises at least one non-transitory computer-readable medium having computer-readable program code portion embodied therein, the computer-readable program code portions which when executed by a processing device are configured to cause a processor to:
receive, using a network interface and via a communication network, a first trap from a first networked device, wherein the first trap indicates a first triggered threshold event and a first timestamp associated with the first triggered threshold event;
identify the first triggered threshold event and the first timestamp;
receive, using the network interface and via the communication network, a second trap from a second networked device, wherein the second trap indicates a second triggered threshold event associated with the first triggered threshold event and a second timestamp associated with the second triggered threshold event, and wherein the second networked device has a link relationship with the first networked device;
identify the link relationship, the second triggered threshold event, and the second timestamp;
determine whether the first trap is a redundant alert signal by determining whether an interval between the first timestamp and the second timestamp exceeds an interval threshold, wherein the interval threshold is assigned based on network flow telemetry information between the first networked device and the second networked device;
trigger, only in response to determining that the interval exceeds the interval threshold, generation of a ticket associated with the first trap by transferring the first trap to a ticket generation engine; and
determine, in response to determining that the interval exceeds the interval threshold, that the first trap is a non-redundant alert signal.

10. The computer program product of claim 9, wherein the processing device is further configured to:
inhibit, in response to determining that the interval does not exceed the interval threshold, the generation of the ticket associated with the first trap; and
determine, in response to determining that the interval does not exceed the interval threshold, that the first trap is the redundant alert signal.

11. The computer program product of claim 9, wherein the processing device is further configured to:
receive, using the network interface and via the communication network, a third trap from the first networked device, wherein the third trap indicates a third triggered threshold event and a third timestamp associated with the third triggered threshold event;
identify the third triggered threshold event and the third timestamp;
trigger, in response to not receiving a fourth trap from the second network device, the generation of another ticket associated with the third trap; and
determine, in response to not receiving a fourth trap from the second network device, that the third trap is the non-redundant alert signal.

12. The computer program product of claim 9, wherein the processing device is further configured to:
receive, using the network interface and via the communication network, an alert information from a third networked device and associated with the first triggered threshold event, wherein the third networked device has the link relationship with the first networked device; and
when triggering the generation of the ticket associated with the first trap, provide the alert information to the ticket generation engine for inclusion in the ticket.

13. The computer program product of claim 9, wherein a protocol used by the first trap to transmit the first triggered threshold event and the first timestamp is different from another protocol used by the second trap to transmit the second triggered threshold event and the second timestamp.

14. The computer program product of claim 9, wherein the network flow telemetry information comprises network bandwidth, data block analysis, and request rate monitoring data.

15. A computer-implemented method for trap chatter reduction in distributed network environments, the method comprising:
receiving, using a network interface and via a communication network, a first trap from a first networked device, wherein the first trap indicates a first triggered threshold event and a first timestamp associated with the first triggered threshold event;
identifying the first triggered threshold event and the first timestamp;
receiving, using the network interface and via the communication network, a second trap from a second networked device, wherein the second trap indicates a second triggered threshold event associated with the first triggered threshold event and a second timestamp associated with the second triggered threshold event, and wherein the second networked device has a link relationship with the first networked device;
identifying the link relationship, the second triggered threshold event, and the second timestamp;
determining whether the first trap is a redundant alert signal by determining whether an interval between the first timestamp and the second timestamp exceeds an interval threshold, wherein the interval threshold is assigned based on network flow telemetry information between the first networked device and the second networked device;
triggering, only in response to determining that the interval exceeds the interval threshold, generation of a ticket associated with the first trap by transferring the first trap to a ticket generation engine; and
determining, in response to determining that the interval exceeds the interval threshold, that the first trap is a non-redundant alert signal.

16. The computer-implemented method of claim 15, wherein the computer-implemented method is further configured for:
inhibiting, in response to determining that the interval does not exceed the interval threshold, the generation of the ticket associated with the first trap; and
determining, in response to determining that the interval does not exceed the interval threshold, that the first trap is the redundant alert signal.

17. The computer-implemented method of claim 15, wherein the computer-implemented method is further configured for:
receiving, using the network interface and via the communication network, a third trap from the first networked device, wherein the third trap indicates a third triggered threshold event and a third timestamp associated with the third triggered threshold event;
identifying the third triggered threshold event and the third timestamp;
triggering, in response to not receiving a fourth trap from the second network device, the generation of another ticket associated with the third trap; and
determining, in response to not receiving a fourth trap from the second network device, that the third trap is the non-redundant alert signal.

18. The computer-implemented method of claim 15, wherein the computer-implemented method is further configured for:
receiving, using the network interface and via the communication network, an alert information from a third networked device and associated with the first triggered threshold event, wherein the third networked device has the link relationship with the first networked device; and
when triggering the generation of the ticket associated with the first trap, providing the alert information to the ticket generation engine for inclusion in the ticket.

19. The computer-implemented method of claim 15, wherein a protocol used by the first trap to transmit the first triggered threshold event and the first timestamp is different from another protocol used by the second trap to transmit the second triggered threshold event and the second timestamp.

20. The computer-implemented method of claim 15, wherein the network flow telemetry information comprises network bandwidth, data block analysis, and request rate monitoring data.
